(19) United States
(12) Patent Application Publication
(10) Pub. No.: US 2013/0064531 A1
(43) Pub. Date: Mar. 14, 2013

(54) ZOOM FLASH WITH NO MOVING PARTS

(71) Applicants: Bruce Harold Pillman, Rochester, NY (US); John Norvold Border, Walworth, NY (US); Joseph Raymond Bietry, Rochester, NY (US)

(72) Inventors: Bruce Harold Pillman, Rochester, NY (US); John Norvold Border, Walworth, NY (US); Joseph Raymond Bietry, Rochester, NY (US)

(21) Appl. No.: 13/230,960

(22) Filed: Sep. 13, 2011

(51) Int. Cl. G03B 15/05

(52) U.S. Cl. 396/62

(57) ABSTRACT

A camera system having an electronic flash with a variable illumination angle, comprising: an image forming system having a user-selectable field-of-view for forming an image of a scene onto an image plane; an electronic flash system including a plurality of fixed focal length illumination lenses having two or more different focal lengths and one or more light emitters positioned behind each of the illumination lenses, the light emitters being positioned relative to their respective illumination lenses to provide two or more different illumination angles onto the scene; and a flash controller that selectively fires different subsets of the light emitters responsive to the selected field-of-view of the image forming system.

### FIELD OF THE INVENTION

This invention pertains to the field of flash photography and more particularly to flash photography for a camera having zoom capability.

### BACKGROUND OF THE INVENTION

When operating a digital camera in a flash mode, flash illumination is provided to a scene during image capture. The flash illumination is typically provided by a built-in electronic flash unit. When the digital camera has a zoom lens, or incorporates a digital zoom feature, the field-of-view included in the digital image of the scene is selectable by the user.

To conserve power and enable brighter images of the scene to be captured, it is advantageous to match the scene area illuminated by the flash to the selected field-of-view included in the digital image. For digital cameras having a zoom capability, it is therefore desirable that the scene area illuminated by the flash must be adjustable. In this way, when the selected field-of-view is small (corresponding to a telephoto zoom setting) the flash illumination can be adjusted to provide a narrow illumination angle in order to illuminate a smaller scene area. Likewise, when the selected field-of-view is large (corresponding to a wide angle zoom setting) the flash illumination can be adjusted to provide a wide illumination angle in order to illuminate a larger scene area.

A number of methods for providing flash illumination with an adjustable illumination angle have been proposed. Most commonly, the illumination angle is adjusted using an optical zoom mechanism. For example, U.S. Pat. No. 6,598,986 to Yano, entitled “Zoom strobe device,” teaches a method to control the flash illumination angle by adjusting the position of a flash lamp relative to associated illumination optics. As the flash lamp is moved along the optical axis of the illumination optics, the illumination angle produced by the flash (and the corresponding scene illumination area) changes in size. If the movement mechanism allows the flash lamp to move off-axis with respect to the optical axis of the illumination optics, the pattern of illumination produced by the flash moves off axis as well. A disadvantage to this method is that the flash lamp (or one or more components of the illumination optics) must be mechanically moved, which adds significant cost to the flash system.

U.S. Patent Application Publication 2002/0009297 to Tanabe, entitled “Camera having mechanically linked zoom lens, retractable flash device and variable flash angle,” teaches a similar approach that uses retracting cylindrical lens arrays that can be suitably positioned according to camera focus. Yet another technique involves changing the illumination angle of the flash by varying the relationship of a pair of wave lenses, as disclosed in commonly-assigned U.S. Pat. No. 5,666,564 to Albrecht, entitled “Zoom flash with wave-lens.” While these and related methods have merit for adapting the flash illumination angle for many applications, they require at least some level of mechanical movement and may not be easily adaptable, particularly for compact cameras.

A flash apparatus with a variable illumination angle is disclosed in U.S. Pat. No. 7,298,970 to Liang, entitled “Zoom flash with variable focus lens.” In this case, the flash includes a variable focus lens to change the focal length of the flash illumination optics thereby changing the illumination angle. However, this approach requires the use of a variable focus lens which is costly.

U.S. Patent Application Publication 2002/0191102 to Yuyama, entitled “Light emitting device, camera with light emitting device, and image pickup method,” describes an array of light emitting diodes (LEDs) for a flash. The LEDs are assembled in rows of red, green and blue respectively. The number of LEDs used in the flash illumination is determined based on an analysis of a preview image of the scene, where the analysis determines the brightness of the scene and the color of the ambient lighting. The LEDs are not adjusted based on zoom setting.

U.S. Patent Application Publication 2010/0014274 to Shyu et al., entitled “LED array flash for cameras,” utilizes a linear array of LEDs with primary and secondary lenses in a flash to provide partially overlapped areas of illumination. The illumination pattern provided by the linear array of LEDs is not suited to switching between telephoto and wide angle imaging.

U.S. Pat. No. 7,223,956 to Yoshida, entitled “Electronic imaging system,” describes a flash illumination system including an array of LEDs where the lighting axes are different from one another to provide illumination of different areas of the scene. A flash controller fires different combinations of the LEDs depending on the operating mode or the zoom ratio selected by the user. In this patent, each LED illuminates a different portion of the scene so that providing sufficient illumination for a telephoto image is difficult and nonuniformity of illumination is an issue due to the many overlapped illumination regions between the LEDs.

While conventional solutions can provide some measure of variable flash illumination angle, there remains a need for a zoom flash mechanism that is relatively inexpensive and mechanically robust for use in low-cost compact cameras, both digital and film-based.

### SUMMARY OF THE INVENTION

The present invention provides a camera system having an electronic flash with a variable illumination angle, comprising:

an image forming system having a user-selectable field-of-view for forming an image of a scene onto an image plane;

an electronic flash system including:
a plurality of fixed focal length illumination lenses having two or more different focal lengths; and
one or more light emitters positioned behind each of the illumination lenses, the light emitters being positioned relative to their respective illumination lenses to provide two or more different illumination angles onto the scene; and

a flash controller that selectively fires different subsets of the light emitters responsive to the selected field-of-view of the image forming system.

This invention has the advantage that power is conserved during flash operations as the illuminated area in the scene is reduced as the zoom setting is increased.

It has the additional advantage that the flash unit is simple and can be made very thin.

### BRIEF DESCRIPTION OF THE DRAWINGS

FIG. 1 is a high-level diagram showing the components of a digital camera system;

FIG. 2 is a flow diagram depicting typical image processing operations used to process digital images in a digital camera;

FIG. 3 is an illustration of a scene as imaged with different zoom settings;

FIG. 4 is a schematic drawing of an electronic flash including light emitters and corresponding illumination lenses having different focal length lenses according to one embodiment;

FIG. 5 is an illustration of a camera incorporating the electronic flash of FIG. 4;

FIGS. 6A and 6B are schematic drawings of individual light emitters with associated illumination lenses;

FIG. 7 is a schematic drawing of an electronic flash including light emitters and corresponding illumination lenses having different focal length lenses according to another embodiment;

FIG. 8 is a schematic drawing showing the electronic flash configuration of FIG. 4 used in combination with a main lens;

FIG. 9 is a schematic drawing showing the electronic flash configuration of FIG. 7 used in combination with a main lens.

FIG. 10 is a flow diagram showing a process for selecting and firing a subset of light emitters;

FIG. 11 is an illustration of a camera incorporating multiple LED flash arrays according to an embodiment of the present invention; and

FIG. 12 is an illustration of a camera incorporating a large LED flash array according to an embodiment of the present invention.

It is to be understood that the attached drawings are for purposes of illustrating the concepts of the invention and may not be to scale.

### DETAILED DESCRIPTION OF THE INVENTION

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

Because digital cameras employing imaging devices and related circuitry for signal capture and processing, and display are well known, the present description will be directed in particular to elements forming part of, or cooperating more directly with, the method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

The following description of a digital camera will be familiar to one skilled in the art. It will be obvious that there are many variations of this embodiment that are possible and are selected to reduce the cost, add features or improve the performance of the camera.

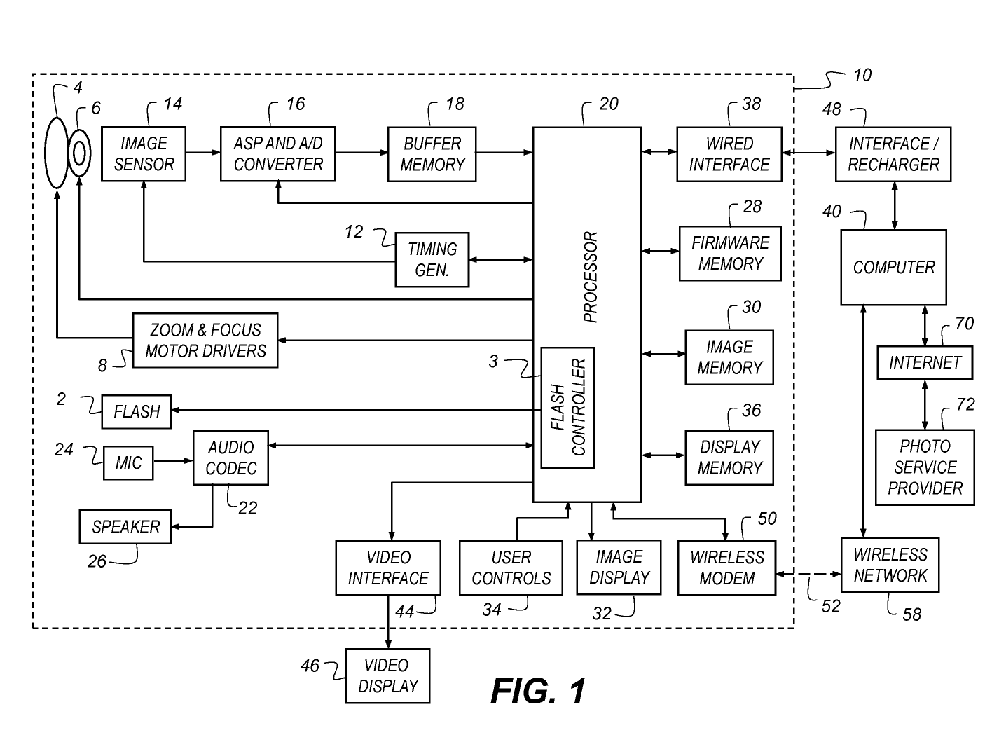

FIG. 1 depicts a block diagram of a digital photography system, including a digital camera 10 in accordance with the present invention. Preferably, the digital camera 10 is a portable battery operated device, small enough to be easily handheld by a user when capturing and reviewing images. The digital camera 10 produces digital images that are stored as digital image files using image memory 30. The phrase “digital image” or “digital image file”, as used herein, refers to any digital image file, such as a digital still image or a digital video file.

In some embodiments, the digital camera 10 captures both motion video images and still images. The digital camera 10 can also include other functions, including, but not limited to, the functions of a digital music player (e.g. an MP3 player), a mobile telephone, a GPS receiver, or a programmable digital assistant (PDA).

The digital camera 10 includes a lens 4 having an adjustable aperture and adjustable shutter 6. In a preferred embodiment, the lens 4 is a zoom lens to provide a selectable field-of-view. Lens 4 is controlled by zoom and focus motor drives 8. Digital camera 10 can also have a digital zoom wherein a portion of the captured digital image is selected for further image processing. The lens 4 focuses light from a scene (not shown) onto an image sensor 14, for example, a single-chip color CCD or CMOS image sensor.

The output of the image sensor 14 is converted to digital form by Analog Signal Processor (ASP) and Analog-to-Digital (A/D) converter 16, and temporarily stored in buffer memory 18. The image data stored in buffer memory 18 is subsequently manipulated by a processor 20, using embedded software programs (e.g. firmware) stored in firmware memory 28. In some embodiments, the software program is permanently stored in firmware memory 28 using a read only memory (ROM). In other embodiments, the firmware memory 28 can be modified by using, for example, Flash EPROM memory. In such embodiments, an external device can update the software programs stored in firmware memory 28 using the wired interface 38 or the wireless modem 50. In such embodiments, the firmware memory 28 can also be used to store image sensor calibration data, user setting selections and other data which must be preserved when the camera is turned off. In some embodiments, the processor 20 includes a program memory (not shown), and the software programs stored in the firmware memory 28 are copied into the program memory before being executed by the processor 20.

It will be understood that the functions of processor 20 can be provided using a single programmable processor or by using multiple programmable processors, including one or more digital signal processor (DSP) devices. Alternatively, the processor 20 can be provided by custom circuitry (e.g., by one or more custom integrated circuits (ICs) designed specifically for use in digital cameras), or by a combination of programmable processor(s) and custom circuits. It will be understood that connectors between the processor 20 from some or all of the various components shown in FIG. 1 can be made using a common data bus. For example, in some embodiments the connection between the processor 20, the buffer memory 18, the image memory 30, and the firmware memory 28 can be made using a common data bus.

The processed images are then stored using the image memory 30. It is understood that the image memory 30 can be any form of memory known to those skilled in the art including, but not limited to, a removable Flash memory card, internal Flash memory chips, magnetic memory, or optical memory. In some embodiments, the image memory 30 can include both internal Flash memory chips and a standard interface to a removable Flash memory card, such as a Secure Digital (SD) card. Alternatively, a different memory card format can be used, such as a micro SD card, Compact Flash (CF) card, MultiMedia Card (MMC), xD card or Memory Stick.

The image sensor 14 is controlled by a timing generator 12, which produces various clocking signals to select rows and pixels and synchronizes the operation of the ASP and A/D converter 16. The image sensor 14 can have, for example, 12.4 megapixels (4088×3040 pixels) in order to provide a still image file of approximately 4000×3000 pixels. To provide a color image, the image sensor is generally overlaid with a color filter array, which provides an image sensor having an array of pixels that include different colored pixels. The different color pixels can be arranged in many different patterns. As one example, the different color pixels can be arranged using the well-known Bayer color filter array, as described in commonly assigned U.S. Pat. No. 3,971,065, “Color imaging array” to Bayer, the disclosure of which is incorporated herein by reference. As a second example, the different color pixels can be arranged as described in commonly assigned U.S. Patent Application Publication 2007/0024931 to Compton and Hamilton, entitled “Image sensor with improved light sensitivity,” the disclosure of which is incorporated herein by reference. These examples are not limiting, and many other color patterns may be used.

It will be understood that the image sensor 14, timing generator 12, and ASP and A/D converter 16 can be separately fabricated integrated circuits, or they can be fabricated as a single integrated circuit as is commonly done with CMOS image sensors. In some embodiments, this single integrated circuit can perform some of the other functions shown in FIG. 1, including some of the functions provided by processor 20.

The image sensor 14 is effective when actuated in a first mode by timing generator 12 for providing a motion sequence of lower resolution sensor image data, which is used when capturing video images and also when previewing a still image to be captured, in order to compose the image. This preview mode sensor image data can be provided as HD resolution image data, for example, with 1280×720 pixels, or as VGA resolution image data, for example, with 640×480 pixels, or using other resolutions which have significantly fewer columns and rows of data, compared to the resolution of the image sensor.

The preview mode sensor image data can be provided by combining values of adjacent pixels having the same color, or by eliminating some of the pixels values, or by combining some color pixels values while eliminating other color pixel values. The preview mode image data can be processed as described in commonly assigned U.S. Pat. No. 6,292,218 to Parulski, et al., entitled “Electronic camera for initiating capture of still images while previewing motion images,” which is incorporated herein by reference.

The image sensor 14 is also effective when actuated in a second mode by timing generator 12 for providing high resolution still image data. This final mode sensor image data is provided as high resolution output image data, which for scenes having a high illumination level includes all of the pixels of the image sensor, and can be, for example, a 12 megapixel final image data having 4000×3000 pixels. At lower illumination levels, the final sensor image data can be provided by “binning” some number of like-colored pixels on the image sensor, in order to increase the signal level and thus the “ISO speed” of the sensor.

The zoom and focus motor drivers 8 are controlled by control signals supplied by the processor 20, to provide the appropriate focal length of the lens 4 for the desired zoom setting and to focus the scene onto the image sensor 14. The zoom setting can be selected by the user or selected automatically in response to a remote input or based on an analysis of the image content in a preview image. The exposure level of the image sensor 14 is controlled by controlling the f/number and exposure time of the adjustable aperture and adjustable shutter 6, the exposure period of the image sensor 14 via the timing generator 12, and the gain (i.e., ISO speed) setting of the ASP and A/D converter 16. A flash 2 is also provided which can illuminate the scene. The flash 2 is controlled by a flash controller 3. The processor 20 is generally used to perform the function of the flash controller 3, although in some embodiments a separate component can be used.

The lens 4 of the digital camera 10 can be focused in the first mode by using “through-the-lens” autofocus, as described in commonly-assigned U.S. Pat. No. 5,668,597, entitled “Electronic Camera with Rapid Automatic Focus of an Image upon a Progressive Scan Image Sensor” to Parulski et al., which is incorporated herein by reference. This is accomplished by using the zoom and focus motor drivers 8 to adjust the focus position of the lens 4 to a number of positions ranging between a near focus position to an infinity focus position, while the processor 20 determines the closest focus position which provides a peak sharpness value for a central portion of the image captured by the image sensor 14. The focus distance which corresponds to the closest focus position can then be utilized for several purposes, such as automatically setting an appropriate scene mode, and can be stored as metadata in the image file, along with other lens and camera settings.

The processor 20 produces menus and low resolution color images that are temporarily stored in display memory 36 and are displayed on the image display 32. The image display 32 is typically an active matrix color liquid crystal display (LCD), although other types of displays, such as organic light emitting diode (OLED) displays, can be used. A video interface 44 provides a video output signal from the digital camera 10 to a video display 46, such as a flat panel HDTV display. In preview mode, or video mode, the digital image data from buffer memory 18 is manipulated by processor 20 to form a series of motion preview images that are displayed, typically as color images, on the image display 32. In review mode, the images displayed on the image display 32 are produced using the image data from the digital image files stored in image memory 30.

The graphical user interface displayed on the image display 32 is controlled in response to user input provided by user controls 34. The user controls 34 are used to select various camera modes, such as video capture mode, still capture mode, and review mode, and to initiate capture of still images, recording of motion images. The user controls 34 are also used to set user processing preferences, and to choose between various photography modes based on scene type and taking conditions. In some embodiments, various camera settings may be set automatically in response to analysis of preview image data, audio signals, or external signals such as GPS, weather broadcasts, or other available signals.

In some embodiments, when the digital camera is in a still photography mode the above-described preview mode is initiated when the user partially depresses a shutter button, which is one of the user controls 34, and the still image capture mode is initiated when the user fully depresses the shutter button. The user controls 34 are also used to turn on the camera, control the lens 4, and initiate the picture taking process. User controls 34 typically include some combination of buttons, rocker switches, joysticks, or rotary dials. In some embodiments, some of the user controls 34 are provided by using a touch screen overlay on the image display 32. In other embodiments, the user controls 34 can include a means to receive input from the user or an external device via a tethered, wireless, voice activated, visual or other interface. In other embodiments, additional status displays or images displays can be used.

The camera modes that can be selected using the user controls 34 include a “timer” mode. When the “timer” mode is selected, a short delay (e.g., 10 seconds) occurs after the user fully presses the shutter button, before the processor 20 initiates the capture of a still image.

An audio codec 22 connected to the processor 20 receives an audio signal from a microphone 24 and provides an audio signal to a speaker 26. These components can be used to record and playback an audio track, along with a video sequence or still image. If the digital camera 10 is a multi-function device such as a combination camera and mobile phone, the microphone 24 and the speaker 26 can be used for telephone conversation.

In some embodiments, the speaker 26 can be used as part of the user interface, for example to provide various audible signals which indicate that a user control has been depressed, or that a particular mode has been selected. In some embodiments, the microphone 24, the audio codec 22, and the processor 20 can be used to provide voice recognition, so that the user can provide a user input to the processor 20 by using voice commands, rather than user controls 34. The speaker 26 can also be used to inform the user of an incoming phone call. This can be done using a standard ring tone stored in firmware memory 28, or by using a custom ring-tone downloaded from a wireless network 58 and stored in the image memory 30. In addition, a vibration device (not shown) can be used to provide a silent (e.g., non audible) notification of an incoming phone call.

The processor 20 also provides additional processing of the image data from the image sensor 14, in order to produce rendered sRGB image data which is compressed and stored within a “finished” image file, such as a well-known Exif-JPEG image file, in the image memory 30.

The digital camera 10 can be connected via the wired interface 38 to an interface/recharger 48, which is connected to a computer 40, which can be a desktop computer or portable computer located in a home or office. The wired interface 38 can conform to, for example, the well-known USB 2.0 interface specification. The interface/recharger 48 can provide power via the wired interface 38 to a set of rechargeable batteries (not shown) in the digital camera 10.

The digital camera 10 can include a wireless modem 50, which interfaces over a radio frequency band 52 with the wireless network 58. The wireless modem 50 can use various wireless interface protocols, such as the well-known Bluetooth wireless interface or the well-known 802.11 wireless interface. The computer 40 can upload images via the Internet 70 to a photo service provider 72, such as the Kodak EasyShare Gallery. Other devices (not shown) can access the images stored by the photo service provider 72.

In alternative embodiments, the wireless modem 50 communicates over a radio frequency (e.g. wireless) link with a mobile phone network (not shown), such as a 3GSM network, which connects with the Internet 70 in order to upload digital image files from the digital camera 10. These digital image files can be provided to the computer 40 or the photo service provider 72.

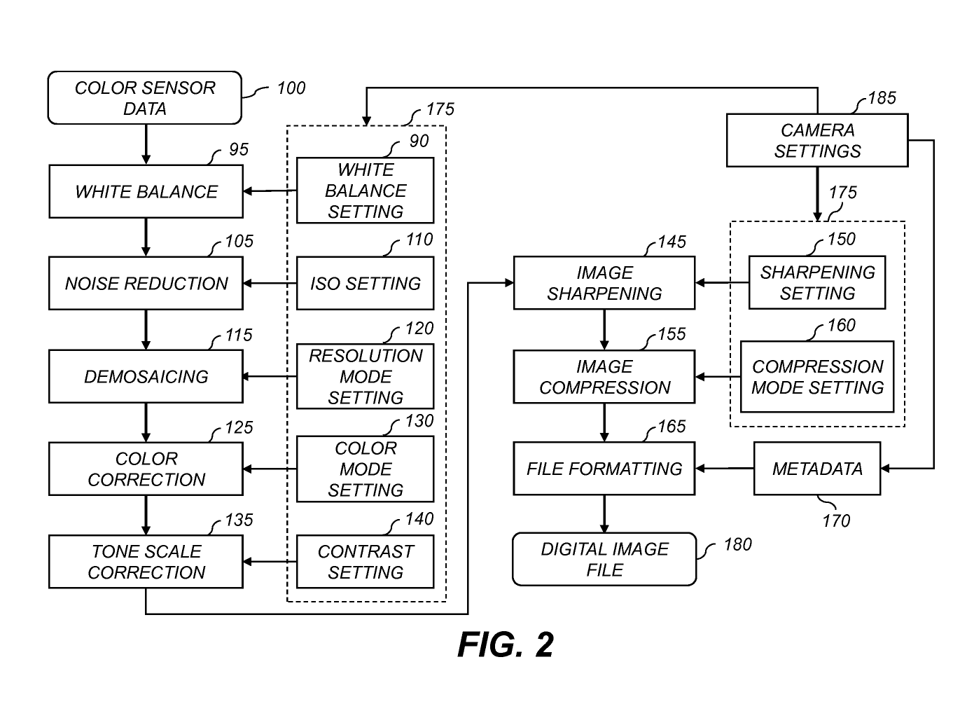

FIG. 2 is a flow diagram depicting image processing operations that can be performed by the processor 20 in the digital camera 10 (FIG. 1) in order to process color sensor data 100 from the image sensor 14 output by the ASP and A/D converter 16. In some embodiments, the processing parameters used by the processor 20 to manipulate the color sensor data 100 for a particular digital image are determined by various photography mode settings 175, which are typically associated with photography modes that can be selected via the user controls 34, which enable the user to adjust various camera settings 185 in response to menus displayed on the image display 32.

The color sensor data 100 which has been digitally converted by the ASP and A/D converter 16 is manipulated by a white balance step 95. In some embodiments, this processing can be performed using the methods described in commonly-assigned U.S. Pat. No. 7,542,077 to Miki, entitled “White balance adjustment device and color identification device”, the disclosure of which is herein incorporated by reference. The white balance can be adjusted in response to a white balance setting 90, which can be manually set by a user, or which can be automatically set by the camera.

The color image data is then manipulated by a noise reduction step 105 in order to reduce noise from the image sensor 14. In some embodiments, this processing can be performed using the methods described in commonly-assigned U.S. Pat. No. 6,934,056 to Gindele et al., entitled “Noise cleaning and interpolating sparsely populated color digital image using a variable noise cleaning kernel,” the disclosure of which is herein incorporated by reference. The level of noise reduction can be adjusted in response to an ISO setting 110, so that more filtering is performed at higher ISO exposure index setting.

The color image data is then manipulated by a demosaicing step 115, in order to provide red, green and blue (RGB) image data values at each pixel location. Algorithms for performing the demosaicing step 115 are commonly known as color filter array (CFA) interpolation algorithms or “deBayering” algorithms. In one embodiment of the present invention, the demosaicing step 115 can use the luminance CFA interpolation method described in commonly-assigned U.S. Pat. No. 5,652,621, entitled “Adaptive color plane interpolation in single sensor color electronic camera,” to Adams et al., the disclosure of which is incorporated herein by reference. The demosaicing step 115 can also use the chrominance CFA interpolation method described in commonly-assigned U.S. Pat. No. 4,642,678, entitled “Signal processing method and apparatus for producing interpolated chrominance values in a sampled color image signal”, to Cok, the disclosure of which is herein incorporated by reference.

In some embodiments, the user can select between different pixel resolution modes, so that the digital camera can produce a smaller size image file. Multiple pixel resolutions can be provided as described in commonly-assigned U.S. Pat. No. 5,493,335, entitled “Single sensor color camera with user selectable image record size,” to Parulski et al., the disclosure of which is herein incorporated by reference. In some embodiments, a resolution mode setting 120 can be selected by the user to be full size (e.g. 3,000×2,000 pixels), medium size (e.g. 1,500×1000 pixels) or small size (750×500 pixels).

The color image data is color corrected in color correction step 125. In some embodiments, the color correction is provided using a 3×3 linear space color correction matrix, as described in commonly-assigned U.S. Pat. No. 5,189,511, entitled “Method and apparatus for improving the color rendition of hardcopy images from electronic cameras” to Parulski, et al., the disclosure of which is incorporated herein by reference. In some embodiments, different user-selectable color modes can be provided by storing different color matrix coefficients in firmware memory 28 of the digital camera 10. For example, four different color modes can be provided, so that the color mode setting 130 is used to select one of the following color correction matrices:

Setting 1 (normal color reproduction)

$$[ \begin{matrix}{R}_{out} \\ {G}_{out} \\ {B}_{out}\end{matrix} ] = [ \begin{matrix}1.50 & - 0.30 & - 0.20 \\ - 0.40 & 1.80 & - 0.40 \\ - 0.20 & - 0.20 & 1.40\end{matrix} ] [ \begin{matrix}{R}_{in} \\ {G}_{in} \\ {B}_{in}\end{matrix} ] \qquad ( 1 )$$

Setting 2 (saturated color reproduction)

$$[ \begin{matrix}{R}_{out} \\ {G}_{out} \\ {B}_{out}\end{matrix} ] = [ \begin{matrix}2.00 & - 0.60 & - 0.40 \\ - 0.80 & 2.60 & - 0.80 \\ - 0.40 & - 0.40 & 1.80\end{matrix} ] [ \begin{matrix}{R}_{in} \\ {G}_{in} \\ {B}_{in}\end{matrix} ] \qquad ( 2 )$$

Setting 3 (de-saturated color reproduction)

$$[ \begin{matrix}{R}_{out} \\ {G}_{out} \\ {B}_{out}\end{matrix} ] = [ \begin{matrix}1.25 & - 0.15 & - 0.10 \\ - 0.20 & 1.40 & - 0.20 \\ - 0.10 & - 0.10 & 1.20\end{matrix} ] [ \begin{matrix}{R}_{in} \\ {G}_{in} \\ {B}_{in}\end{matrix} ] \qquad ( 3 )$$

Setting 4 (monochrome)

$$[ \begin{matrix}{R}_{out} \\ {G}_{out} \\ {B}_{out}\end{matrix} ] = [ \begin{matrix}0.30 & 0.60 & 0.10 \\ 0.30 & 0.60 & 0.10 \\ 0.30 & 0.60 & 0.10\end{matrix} ] [ \begin{matrix}{R}_{in} \\ {G}_{in} \\ {B}_{in}\end{matrix} ] \qquad ( 4 )$$

In other embodiments, a three-dimensional lookup table can be used to perform the color correction step 125.

The color image data is also manipulated by a tone scale correction step 135. In some embodiments, the tone scale correction step 135 can be performed using a one-dimensional look-up table as described in U.S. Pat. No. 5,189,511, cited earlier. In some embodiments, a plurality of tone scale correction look-up tables is stored in the firmware memory 28 in the digital camera 10. These can include look-up tables which provide a “normal” tone scale correction curve, a “high contrast” tone scale correction curve, and a “low contrast” tone scale correction curve. A user selected contrast setting 140 is used by the processor 20 to determine which of the tone scale correction look-up tables to use when performing the tone scale correction step 135.

The color image data is also manipulated by an image sharpening step 145. In some embodiments, this can be provided using the methods described in commonly-assigned U.S. Pat. No. 6,192,162 entitled “Edge enhancing colored digital images” to Hamilton, et al., the disclosure of which is incorporated herein by reference. In some embodiments, the user can select between various sharpening settings, including a “normal sharpness” setting, a “high sharpness” setting, and a “low sharpness” setting. In this example, the processor 20 uses one of three different edge boost multiplier values, for example 2.0 for “high sharpness”, 1.0 for “normal sharpness”, and 0.5 for “low sharpness” levels, responsive to a sharpening setting 150 selected by the user of the digital camera 10.

The color image data is also manipulated by an image compression step 155. In some embodiments, the image compression step 155 can be provided using the methods described in commonly-assigned U.S. Pat. No. 4,774,574, entitled “Adaptive block transform image coding method and apparatus” to Daly et al., the disclosure of which is incorporated herein by reference. In some embodiments, the user can select between various compression settings. This can be implemented by storing a plurality of quantization tables, for example, three different tables, in the firmware memory 28 of the digital camera 10. These tables provide different quality levels and average file sizes for the compressed digital image file 180 to be stored in the image memory 30 of the digital camera 10. A user selected compression mode setting 160 is used by the processor 20 to select the particular quantization table to be used for the image compression step 155 for a particular image.

The compressed color image data is stored in a digital image file 180 using a file formatting step 165. The image file can include various metadata 170. Metadata 170 is any type of information that relates to the digital image, such as the model of the camera that captured the image, the size of the image, the date and time the image was captured, and various camera settings, such as the lens focal length, the exposure time and f-number of the lens, and whether or not the camera flash fired. In a preferred embodiment, all of this metadata 170 is stored using standardized tags within the well-known Exif-JPEG still image file format. In a preferred embodiment of the present invention, the metadata 170 includes information about various camera settings 185, including the photography mode settings 175.

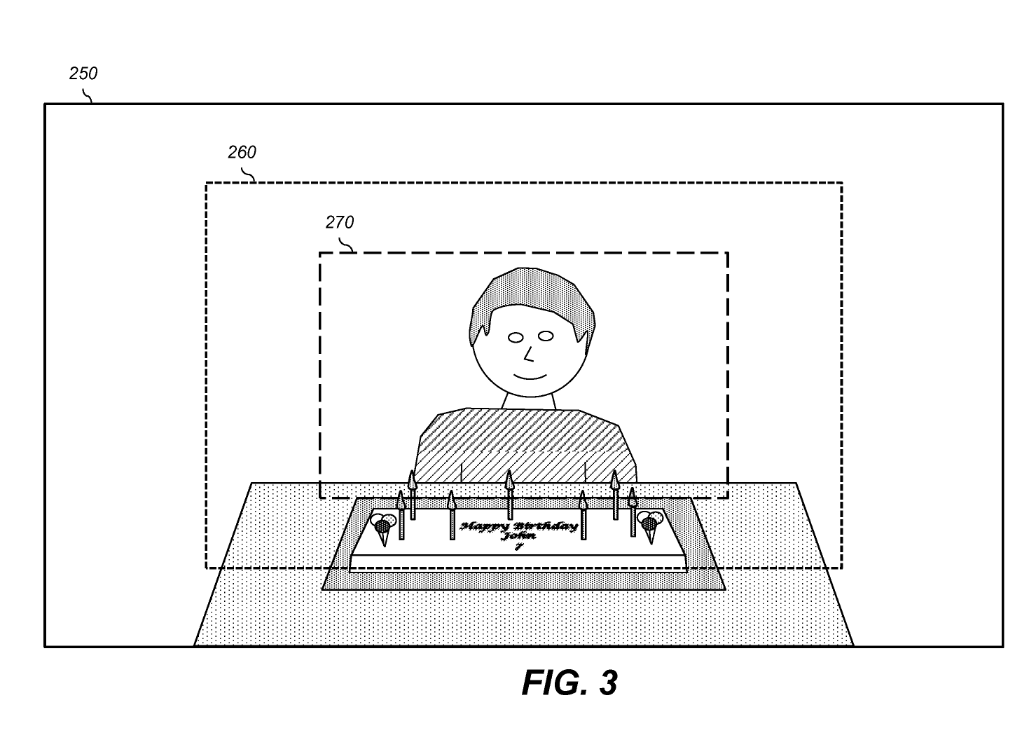

When the lens 4 (FIG. 1) used for a digital camera 10 is a zoom lens, the field-of-view in the scene captured in the digital image will be different depending on the zoom setting selected by the user. FIG. 3 is an illustration of the effective fields of view contained in digital images captured by a digital camera at a fixed position relative to a scene, where the lens 4 is set to different zoom settings. Wide angle field-of-view 250 corresponds to a wide angle image captured with a low zoom setting. Medium field-of-view 260 corresponds to an intermediate field-of-view image captured with an intermediate zoom setting. Telephoto field-of-view 270 corresponds to a telephoto image captured with a high zoom setting.

Most digital cameras 10 that incorporate a zoom lens 4 together with a built-in electronic flash 2 provide a flash illumination angle that matches the widest field-of-view of the zoom lens 4 (e.g., wide angle field-of-view 250), regardless of the zoom setting selected by the user. This approach results in light from the flash 2 being wasted when the digital camera 10 is operated with a higher zoom setting. The wasted light requires higher power usage for the flash 2 in order to provide a desired level of brightness on the scene. Additionally, by illuminating more of the scene than is required for the desired field-of-view, the brightness of the illumination in the desired field-of-view is reduced, which makes for darker images or increased noise levels in the captured images. In some cases, it can also result in more blur for moving objects in the scene if the camera exposure control system increases the exposure time to compensate for the low flash illumination level.

The present invention provides an electronic flash 2 for a camera system that includes an array of light emitters (e.g., LEDs) positioned behind illumination lenses with different focal lengths to provide different illumination angles, thereby illuminating different portions of the scene. The processor 20 selects different subsets of the light emitters to be fired responsive to the zoom setting of the lens 4. For cases where the user has selected a low zoom setting for wide angle imaging, light emitters in the flash are fired that provide a wide illumination angle such that a large field-of-view of the scene is illuminated. Conversely, for cases where the user has selected a high zoom setting for telephoto imaging, light emitters in the flash are fired that provide a narrow illumination angle such that a smaller field-of-view of the scene is illuminated.

According to a preferred embodiment, the invention provides an electronic flash 2 including an array of LEDs, each positioned behind a fixed focal length illumination lens, wherein at least two different focal lengths are used to provide different illumination angles. This configuration has the advantage that it is simple to manufacture and can be made very thin.

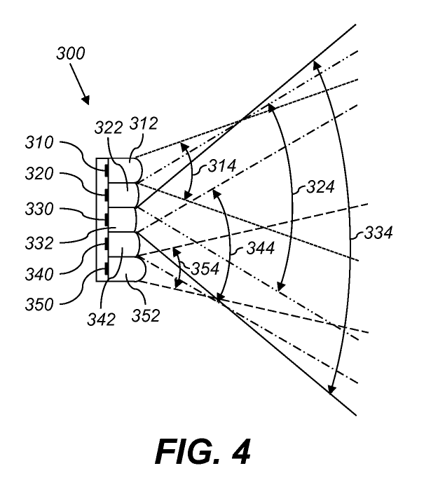

Turning now to FIG. 4, a schematic drawing is shown for an electronic flash 300 including an array of LEDs 310, 320, 330, 340 and 350 according to one embodiment. While the electronic flash 300 is shown with a linear array of LEDs (i.e., a 1×5 array), the invention includes other arrangements of LEDs such as square arrays (e.g., a 5×5 array), rectangular arrays (e.g., a 2×5 array), hexagonal arrays or any other appropriate geometrical pattern. In some cases, the LEDs can be arranged in a pattern which has decorative as well as functional attributes. For example, they can be arranged in a star pattern or a circular pattern. In this embodiment, each of the LEDs 310, 320, 330, 340 and 350 in the electronic flash 300 is positioned behind an associated illumination lens 312, 322, 332, 342 and 352 to provide a corresponding illumination angle 314, 324, 334, 344 and 354 to illuminate a portion of the scene with a relatively uniform cone of light. While the illustrated embodiment uses LED light sources, it will be obvious to one skilled in the art that other types of light sources, including flash lamps and organic light emitting diodes (OLEDs), can also be used in accordance with the present invention. In some embodiments, different light source types (e.g., LEDs and OLEDs) can be used in combination in a single camera system. The electronic flash 300 has the desirable characteristics that it is simple to manufacture and can be made very thin.

In the example embodiment of FIG. 4, each of the illumination lenses 312, 322, 332, 342 and 352 has a different focal length so that different illumination angles 314, 324, 334, 344 and 354 are provided for each LED 310, 320, 330, 340 and 350. For example, LED 330 has an associated illumination lens 332 with a long focal length so that a wide illumination cone angle 334 is provided, while LED 350 has an associated illumination lens 352 with a short focal length so that a narrow illumination cone angle 354 is provided. The other illumination lens 310, 320 and 340 have intermediate focal lengths, and provide corresponding intermediate illumination angles 314, 324 and 344.

In the illustrated example, the longest focal length illumination lenses 320, 330 and 340 are located in the center of the array, while the shorter focal length illumination lenses 310 and 350 are located at the edges of the array. However, this is not a requirement. In other embodiments, the lenses can be arranged in any arbitrary order.

In some embodiments, the illumination lens 312, 322, 332, 342 and 352 are circularly symmetric lenses having one or more spherical, aspherical or Fresnel surfaces. In other embodiments, the illumination lens 312, 322, 332, 342 and 352 can be cylindrical lenses.

The embodiment of FIG. 4 shows a single LED 310, 320, 330, 340 and 350 positioned behind each illumination lens 312, 322, 332, 342 and 352. In other embodiments, there can be multiple LEDs behind some or all of the illumination lenses. For example, a 2×2 array of LEDs can be positioned behind a particular illumination lens, or a linear array of LEDs can be positioned behind a cylindrical illumination lens.

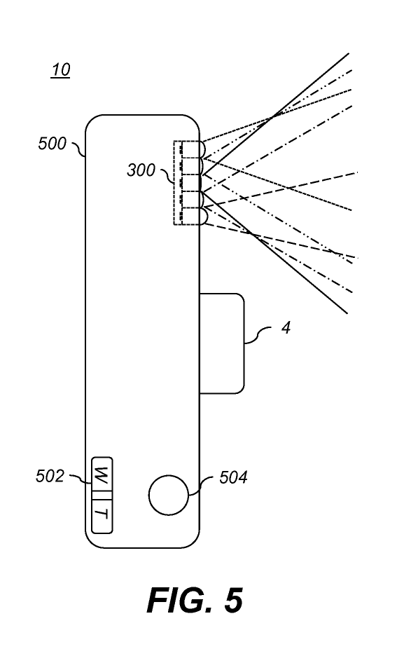

FIG. 5 shows a top view of a digital camera 10 including the electronic flash 300 from FIG. 4. The electronic flash 300 is positioned in a camera body 500 adjacent to lens 4. The lens 4 is a zoom lens that provides a user selectable field-of-view of the scene. The digital camera 10 also includes other features such as a zoom control 502 for controlling the zoom setting of the lens 4, and an image capture control 504 (e.g., a shutter button) for initiating image capture. As discussed earlier, the digital camera 10 also includes a flash controller 3 (FIG. 1) that selectively fires subsets of the LED light emitters in the electronic flash 300 responsive to the zoom setting of the lens 4. In some embodiments, the function of the flash controller 3 is provided by the processor 20 (FIG. 1). In other embodiments, the flash controller 3 can be a separate component.

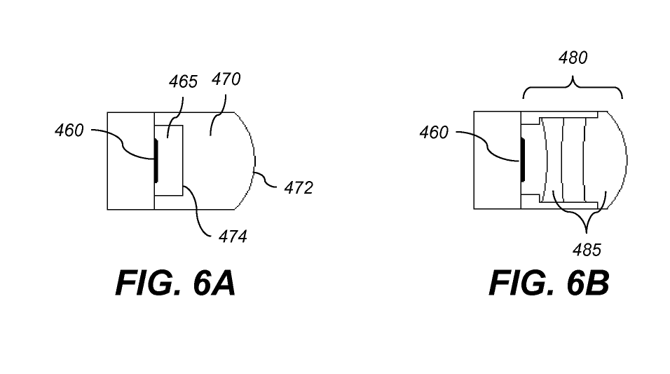

In the embodiment of FIG. 4, the illumination lenses 312, 322, 332, 342 and 352 are made using a single optical element with a curved front surface and a planar rear surface. In this configuration, the illumination lenses 312, 322, 332, 342 and 352 can be conveniently positioned in contact with the array of LEDs 310, 320, 330, 340 and 350. In other embodiments, the illumination lenses may have other configurations and may include two or more optical elements, with an arbitrary number of curved surfaces. Some examples of alternate lens configurations are shown in FIGS. 6A and 6B.

In FIG. 6A, an LED 460 is positioned behind an illumination lens a simple illumination lens 470 having a curved front surface 472 and a planar rear surface 474. The LED 460 is positioned within a cavity 465 molded into the simple illumination lens 470.

In FIG. 6B, the LED 460 is used in combination with a more complex compound illumination lens 480 with multiple lens elements 485. The multiple lens elements 485 enable the uniformity of illumination provided to the scene to be improved. Stacked arrangements of LED light sources and lenses such as this can be made using any method known in the art. For example, they can be fabricated using the wafer-level manufacturing technique described in U.S. Pat. No. 6,324,010 to Bowen et al., entitled “Optical assembly and a method for manufacturing lens systems.”

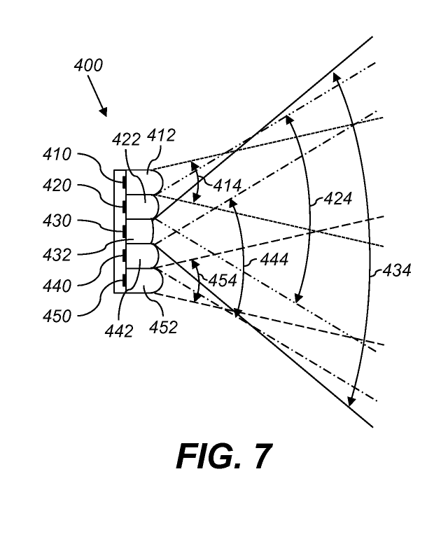

In the arrangement of FIG. 4, each of the illumination lenses 312, 322, 332, 342 and 352 has a different focal length to provide 5 different illumination angles 314, 324, 334, 344 and 354. This is not a requirement, and in some embodiments several of the illumination lenses can have the same focal length. For example, FIG. 7 shows an alternate embodiment in which electronic flash 400 includes LEDs 410, 420, 430, 440 and 450 and associated illumination lenses 412, 422, 432, 442 and 452 providing illumination angles 414, 424, 434, 444 and 454. In this example, the pair of illumination lenses 412 and 452 have the same short focal length and provide equivalent narrow illumination angles 414 and 454. Likewise, the pair of illumination lenses 422 and 442 have the same intermediate focal length and provide equivalent intermediate illumination angles 424 and 444. The central illumination lens 432 has a long focal length and provides a wide illumination angle 444. By providing some of the illumination lenses in pairs, it is possible to provide more uniform illumination about the center of the scene being imaged.

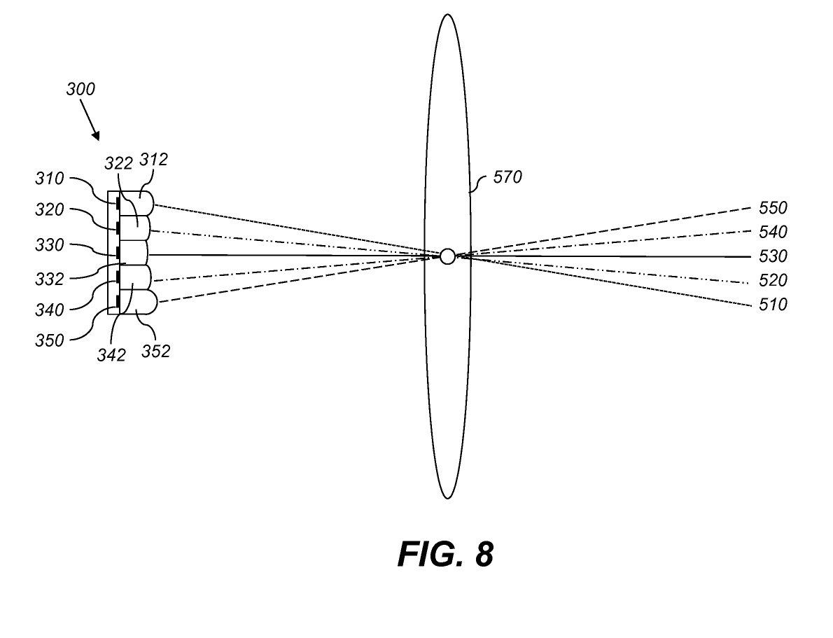

FIG. 8 shows an alternate embodiment where the electronic flash 300 from FIG. 4 is combined with a main lens 570 to further control the distribution of the light from the electronic flash 300 onto the scene. When the distance between the LEDs 310, 320, 330, 340 and 350 is significant compared to the distance to the main lens 570, the illumination beams from each LED will point in different directions coming out of the main lens 570, as illustrated by the chief rays 510, 520, 530, 540 and 550. In some configurations, this feature can be exploited by locating the electronic flash 300 off the optical axis of the main lens 570 to control the overall direction of the flash illumination. This can be used to correct for parallax errors arising from the flash being located away from the camera lens. Main lens 570 can also incorporate a wedge feature to provide directional control. This directional control is particularly useful when the subject is very close, for example, doing macrophotography. In some embodiments, the lateral position of the LEDs 310, 320, 330, 340 and 350 behind the illumination lenses 312, 322, 332, 342 and 352 can be adjusted to control the direction of the illumination beam from each LED such that it is directed toward the center of the main lens 570.

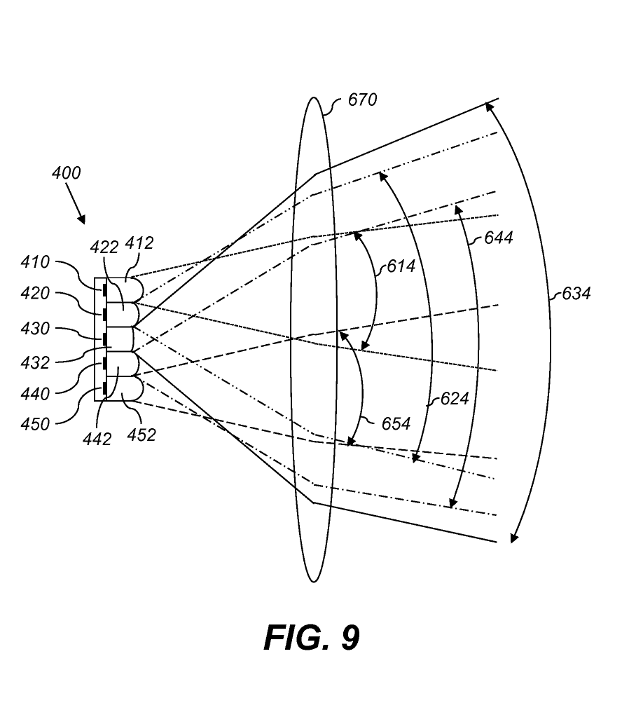

Similar to FIG. 8, FIG. 9 shows the flash 400 from FIG. 7 combined with a main lens 670 to further focus the light from the flash onto the scene. In this case, the illumination cone angles 414, 424, 434, 444 and 454 in FIG. 7 are reduced to the illumination cone angles 614, 624, 634, 644 and 654, respectively. By specifying the lateral location of individual LEDs in each group relative to the optical axis the individual illumination lenses 412, 422, 432, 442 and 452, and relative to the optical axis of the main lens 670, the direction of the illumination beams from each light source can be controlled. This is particularly effective when the LEDs are activated in pairs or groups in order to control the uniformity of the overlapping beams. In FIG. 9, the pairs of LEDs are located symmetrically about the optical axis of the main lens 670, but the directional control discussed in relation to FIG. 8 can also be used such that the combined beam is centered in an off-axis direction (e.g., to correct for parallax effects).

In some embodiments, the single main lens 670 in FIG. 9 may be replaced an array of lenses. This can provide additional design flexibility, allowing the cone angle and pointing direction to be independently adjusted for each LED in the array, thereby enabling improved uniformity of the illumination pattern from the electronic flash 400.

As a general design principle, the relative positions and characteristics of the LEDs and associated illumination lenses in the electronic flash are specified to aim the light beams at the portion of the scene that is desired to be illuminated, and to control the overlap of the individual illumination beams to provide substantially uniform illumination of the scene within the user-selected field-of-view associated with the setting of the zoom lens 4 (FIG. 1).

In a further embodiment, the array of LEDs and associated illumination lenses is nonuniform over the array. The nonuniformity of the array can be in terms of the spatial density of the LEDs or in terms of the light intensity of the LEDs. This enables additional light to be supplied preferentially to the center or edges of the field-of-view.

As has been mentioned earlier, a flash controller 3 (FIG. 1) is used to selectively fire different subsets of the light emitters (e.g., the LEDs) responsive to the user-selected field-of-view of the digital camera 10 (FIG. 1). The field-of-view is generally selected by using a user control 34 (FIG. 1) to select a focal length for an adjustable zoom lens 4 (FIG. 1). However, in some embodiments, the field-of-view can also be adjusted by using a “digital zoom” feature where the lens 4 is left at a fixed focal length and the field-of-view is adjusted by digitally processing the captured image to zoom into a smaller region of the scene according to a user-selectable zoom factor. For purposes of this discussion, a digital zoom operation will be viewed as adjusting an “effective focal length” even though the actual focal length of the lens 4 may be unchanged.

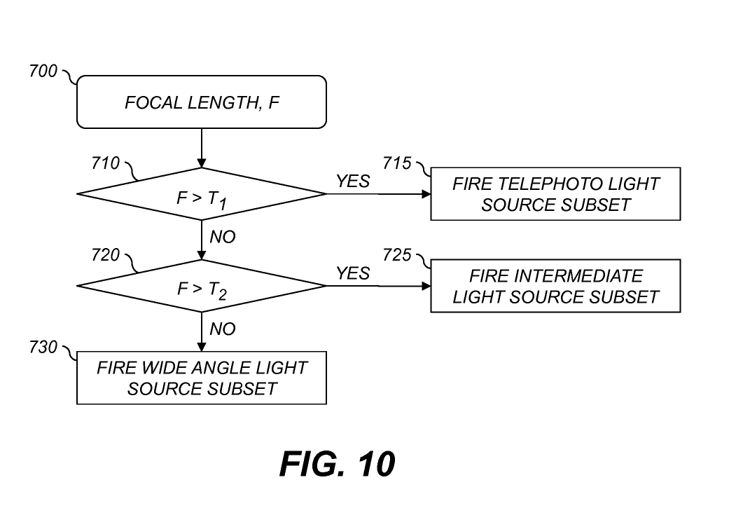

The flash controller 3 can use any method known in the art to select and fire the appropriate subset of the light emitters according to the user selected field-of-view. FIG. 10 shows a flowchart of one method that the flash controller 3 can selectively fire a subset of the light emitters. The input to the flash controller 3 is a focal length 700 (F), which is selected by a user using appropriate user controls 34 (FIG. 1) such as the zoom control 502 (FIG. 5). According to this method a plurality of field-of-view ranges are defined, each of which is associated with a corresponding subset of the light emitters.

A first focal length test 710 is used to compare the focal length to a first predefined threshold T₁. If the focal length is larger than the first predefined threshold (corresponding to the field-of-view range where F>T₁), a fire telephoto light source subset step 715 is used to selectively fire a subset of the light emitters that provide illumination to a narrow field-of-view (for example, the LEDs 410 and 450 in the electronic flash embodiment shown in FIG. 9).

If the first focal length test 710 determines that the focal length is not larger than the first predefined threshold, a second focal length test 720 is used to compare the focal length to a second predefined threshold T₂. If the second focal length test 720 determines that the focal length is larger than the second predefined threshold (corresponding to the field-of-view range where T₂<F≦T₁), a fire intermediate light source subset step 725 is used to selectively fire a subset of the light emitters that provide illumination to an intermediate field-of-view (for example, the LEDs 420 and 440 in the electronic flash embodiment shown in FIG. 9).

Finally, if the second focal length test 720 determines that the focal length is not larger than the second predefined threshold (corresponding to the field-of-view range where F≦T₂), a fire wide angle light source subset step 730 is used to selectively fire a subset of the light emitters that provide illumination to a wide field-of-view (for example, LED 430 in the electronic flash embodiment shown in FIG. 9).

It should be noted that in some embodiments the subsets of the light emitters that are fired for different field-of-view conditions may not be mutually exclusive. In this case, some of the light emitters may be included in a plurality of the different subsets. For example, a particular light emitter may be fired for both a telephoto field-of-view and an intermediate field-of-view.

The amount of light needed for effective flash exposure will generally be a function of the distance between the digital camera 10 (FIG. 1) and the objects in the scene that are being photographed, with higher light levels being needed for more distant objects. Since telephoto field-of-view settings are often associated with photographing scene objects at a larger subject distance, it can be useful in some embodiments to fire the light emitters at a higher power level for narrower field-of-view settings than the power level used for wider field-of-view settings.

In some embodiments, the digital camera 10 (FIG. 1) includes a means for determining distances from the digital camera 10 to objects in the scene. Any technique for providing such distance information can be used with the present invention. In some embodiments, the distance information can be provided using a rangefinder mechanism. In other embodiments, the distance information can be determined from a lens focus position determined by an autofocus system. Other alternatives for obtaining distance information can also be used, such as analysis of preview images captured with and without pre-flash. The flash controller 3 then uses the distance information along with the zoom setting to select the subset of the light emitters that should be fire, or to determine a power level that should be provided by the light emitters when capturing a digital image of the scene. For example, the light emitters can be fired at a higher power level for larger object distances than for shorter object distances. Similarly, in some embodiments more light emitters can be fired for larger object distances than for shorter object distances. The power level of the light emitters can be controlled by controlling a time duration the light emitters are activated, an electrical current level provided to the light emitters, or both.

Some digital cameras 10 utilize a “rolling” shutter exposure control technique where different bands of the digital image are captured at different times. With a rolling shutter exposure, a flash of duration shorter than the time required to read a frame will produce a bright band in the image. This can be prevented by running the light emitters for at least the time required to readout an entire frame. For embodiments where different light emitters are used to illuminate different portions of the scene, only those emitters that are illuminating the portion of the scene that is being captured at a particular time need to be activated. In this way, the power consumption for the flash system can be reduced by not activating light emitters that are not relevant to the portion of the scene that is currently being captured.

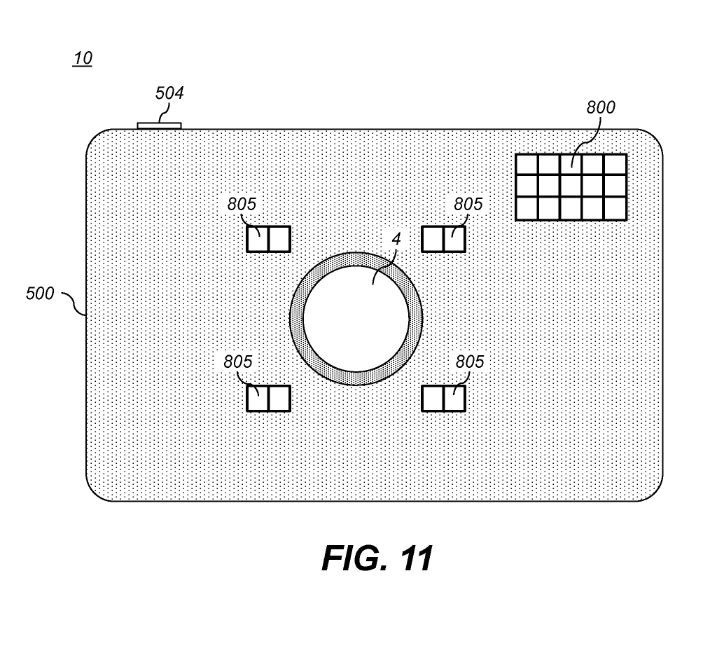

FIG. 11 shows a front view of a digital camera 10 according to another embodiment of the invention that includes a plurality of LED flash arrays 800 and 805, located on the camera body 500. The LED flash arrays 800 and 805 each include a plurality of LED light emitters, coupled with illumination lenses in accordance with the present invention.

The LED flash array 800 is located off of the lens axis, to reduce redeye in normal photography. In some embodiments, the electronic flash 300 of FIG. 4 or the electronic flash 400 of FIG. 7 can be used as the LED flash array 800.

The LED flash arrays 805 are located adjacent to the camera lens 4 in an arrangement to provide more uniform flash illumination for close subject distances. Preferably, the light emitters and illumination lenses that comprise the LED flash arrays 805 are arranged so that the resulting illumination is directed somewhat toward the axis of the lens 4 to provide more uniform illumination on the subject.

The LED flash array 800, together with the LED flash arrays 805, can be considered to be a single electronic flash unit having a plurality of light emitters and corresponding illumination lenses in accordance with the present invention, wherein the particular subset of light emitters that is fired when capturing a particular digital image is determined response to a user-selected field-of-view. In accordance with this embodiment, the light emitters in the LED flash arrays 805 can be selectively fired when the digital camera 10 is set to operate in a macro (close-up) photography mode, or when a determined object distance is less than a predetermined threshold distance. Otherwise, the LED flash array 800 is used as has been described earlier. In some embodiments, some or all of the light emitters in the LED flash arrays 805 can be fired together with light emitters in the LED flash array 800 for cases where the field-of-view is appropriate and where additional light is needed, even if the digital camera 10 is not being operated at a close subject distance.

Embodiments, such as that shown in FIG. 11, which include multiple flash arrays on the body of the camera have the additional advantage that they provide redundancy to avoid a complete loss of illumination in the case where the user unintentionally covers one of the flash arrays with a finger. It also has the advantage that it can be used to provide a more diffuse source of controlled illumination than is easily achieved with a single LED or a flash tube (e.g., a xenon strobe). Such diffuse illumination is generally preferred for applications such as portraiture and for close-up photography.

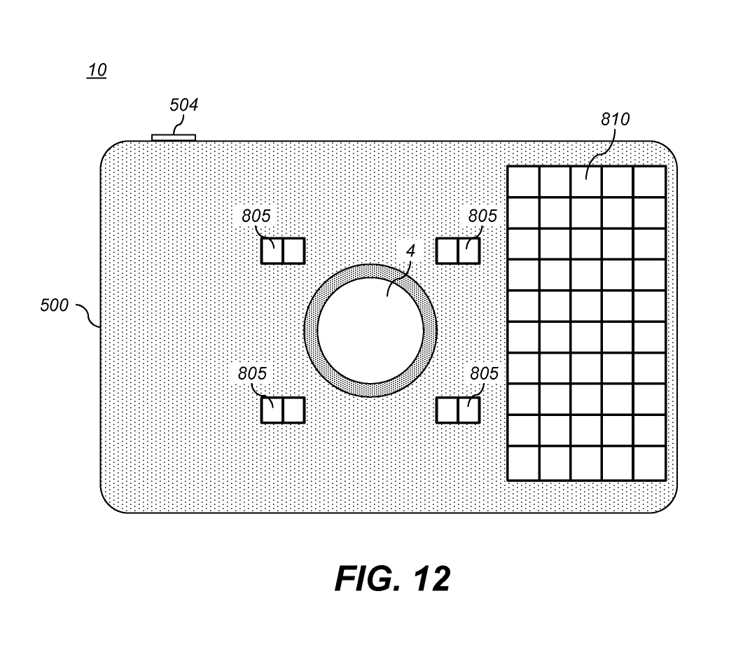

FIG. 12 shows a front view of a digital camera 10 according to another embodiment of the invention which includes an LED flash array 810 that covers a large fraction of the camera body 500. This arrangement has the advantage that it will provide more diffuse flash illumination relative to the LED flash array 805 of FIG. 11.

In a further embodiment, an LED flash array with LEDs arranged to illuminate different portions of the scene can be controlled responsive to analysis of the scene and distance to objects in the scene to provide more illumination power for portions of the scene corresponding to more distant objects, thereby improving uniformity in scenes with a large range of distances and reducing overexposure of close objects.

The electronic flash system described herein relative to a digital camera system can also be applied to conventional film cameras. In this case the image is captured with a light-sensitive film placed at the image plane of the lens 4 (FIG. 1) rather than using the image sensor 14.

The invention has been described in detail with particular reference to certain preferred embodiments thereof, but it will be understood that variations and modifications can be effected within the spirit and scope of the invention.

### PARTS LIST

2 flash
3 flash controller
4 lens
6 adjustable aperture and adjustable shutter
8 zoom and focus motor drives
10 digital camera
12 timing generator
14 image sensor
16 ASP and A/D Converter
18 buffer memory
20 processor
22 audio codec
24 microphone
26 speaker
28 firmware memory
30 image memory
32 image display
34 user controls
36 display memory
38 wired interface
40 computer
44 video interface
46 video display
48 interface/recharger
50 wireless modem
52 radio frequency band
58 wireless network
70 Internet
72 photo service provider
90 white balance setting
95 white balance step
100 color sensor data
105 noise reduction step
110 ISO setting
115 demosaicing step
120 resolution mode setting
125 color correction step
130 color mode setting
135 tone scale correction step
140 contrast setting
145 image sharpening step
150 sharpening setting
155 image compression step
160 compression mode setting
165 file formatting step
170 metadata
175 photography mode settings
180 digital image file
185 camera settings
250 wide angle field-of-view
260 medium field-of-view
270 telephoto field-of-view
300 electronic flash
310 LED
312 illumination lens
314 illumination angle
320 LED
322 illumination lens
324 illumination angle
330 LED
332 illumination lens
334 illumination angle
342 illumination lens
344 illumination angle
350 LED
352 illumination lens
354 illumination angle
400 electronic flash
410 LED
412 illumination lens
414 illumination angle
420 LED
422 illumination lens
424 illumination angle
430 LED
432 illumination lens
434 illumination angle
440 LED
442 illumination lens
444 illumination angle
450 LED
452 illumination lens
454 illumination angle
460 LED
465 cavity
470 simple illumination lens
472 front surface
474 rear surface
480 compound illumination lens
485 lens elements
500 camera body
502 zoom control
504 image capture control
510 chief ray
520 chief ray
530 chief ray
540 chief ray
550 chief ray
570 main lens
670 main lens
700 focal length
710 first focal length test
715 fire telephoto light source subset step
720 second focal length test
725 fire intermediate light source subset step
730 fire wide angle light source subset step
800 LED flash array
805 LED flash array
810 LED flash array

1. A camera system having an electronic flash with a variable illumination angle, comprising:
an image forming system having a user-selectable field-of-view for forming an image of a scene onto an image plane;
an electronic flash system including:
a plurality of fixed focal length illumination lenses, each having an associated focal length, wherein at least two of the illumination lenses have focal lengths that are different from one another; and
one or more light emitters positioned behind each of the illumination lenses, the light emitters being positioned relative to their respective illumination lenses to provide two or more different illumination angles onto the scene, wherein an array of two or more light emitters is positioned behind at least one of the illumination lenses; and
a flash controller that selectively fires different subsets of the light emitters responsive to the selected field-of-view of the image forming system.

2. The camera system of claim 1 further including a subject distance determining subsystem for determining a subject distance between the camera system and a subject in the scene, and wherein the selection of the subset of the light emitters that are selectively fired is also responsive to a subject distance determined by the subject distance determining subsystem.

3. The camera system of claim 1 further including a subject distance determining subsystem for determining a subject distance between the camera system and a subject in the scene, and wherein a power level for at least some of the light emitters is adjusted responsive to a determined subject distance.

4. The camera system of claim 3 wherein the power level of the light emitters is adjusted by controlling a time duration that the light emitters are activated or by controlling an electrical current level provided to the light emitters.

5. The camera system of claim 1 wherein the image forming system includes a variable focal length zoom lens system for providing the user-selectable field-of-view.

6. The camera system of claim 1 wherein the image forming system having a user-selectable field-of-view includes a data processor for performing a digital zoom operation using a user-selectable zoom factor to provide the user-selectable field-of-view.

7. The camera system of claim 1 wherein the light emitters are arranged in a linear array, a square array, a rectangular array or a hexagonal array.

8. The camera system of claim 1 wherein the light emitters are arranged in a plurality of arrays that are spatially separated from each other on the camera body.

9. The camera system of claim 8 wherein the image forming system includes an imaging lens, and wherein at least some of the arrays of light emitters that are arranged in spatially separated positions around the imaging lens.

10. (canceled)

11. The camera system of claim 1 wherein the position of the light emitters relative to the illumination lenses is specified to control an illumination direction.

12. The camera system of claim 11 wherein different light emitters are directed to illuminate different portions of the scene.

13. The camera system of claim 12 wherein a plurality of light emitters are used to illuminate the scene for at least one selected field-of-view such that illumination patterns from the plurality of light emitters combine to illuminate the scene over the selected field-of-view with sufficient uniformity.

14. The camera system of claim 1 wherein the flash controller selects the subset of the light emitters to be fired by:
defining a plurality of field-of-view ranges;
defining a subset of the light emitters to be associated with each of the field-of-view ranges;
determining the field-of-view range that corresponds to the selected field-of-view of the image forming system; and
selecting the subset of light emitters corresponding to the determined field-of-view range.

15. The camera system of claim 1 wherein at least some of the illumination lenses are compound lenses including a plurality of lens elements.

16. The camera system of claim 1 wherein at least some of the illumination lenses are cylinder lenses.

17. The camera system of claim 1 wherein the light emitters are LEDs, OLEDs or flash lamp sources or a combination thereof.

18. The camera system of claim 1 further including an image sensor array located at the image plane for capturing a digital image of the scene.
